(19) United States
(12) Patent Application Publication
(10) Pub. No.: US 2026/0346619 A1
(43) Pub. Date: Nov. 5, 2026

(54) Assembly and Method for Mounting a Control Panel

(71) Applicant: Zebra Technologies Corporation, Lincolnshire, IL (US)

(72) Inventors: Timothy T. Anderson, Antioch, IL (US); Yong Liu, Guangzhou (CN)

(73) Assignee: Zebra Technologies Corporation, Lincolnshire, IL (US)

(21) Appl. No.: 19/124,781

(22) PCT Filed: Oct. 28, 2022
(86) PCT No.: PCT/CN2022/128254

§ 371 Date: Apr. 25, 2025

(51) Int. Cl. B41J 3/46

(52) U.S. Cl. CPC B41J 3/46

(57) ABSTRACT

An embodiment of the present invention includes media processing device having: a housing having a front portion, rear portion, and side portions, the front portion of the housing defining a plane; a control panel disposed on the front portion of the housing; the control panel comprising a fastener disposed a rear side of the control panel, the fastener connecting the control panel to the housing and having a long axis parallel to the plane of the front portion of the housing.

### FIELD OF INVENTION

An example embodiment of the present invention relates generally to media processing devices, or specifically printers, and more specifically to printers structured to provide a control panel proximate a front face of the printer.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 illustrates an example printer in accordance with an example embodiment of the present invention;

FIG. 2 illustrates the example printer of FIG. 1, a side portion of a housing with a side panel removed to illustrate inner components in accordance with an example embodiment of the present invention;

FIG. 3 illustrates an enhanced region from FIG. 2 in accordance with an example embodiment of the present invention;

FIG. 4 illustrates elements as shown in FIG. 3 from an orthogonal view;

FIG. 5 illustrates an enhance region of FIG. 2, show in an orthogonal view;

FIG. 6 illustrates a rear view of a control panel of the printer in accordance with an example embodiment of the present invention;

FIG. 7 illustrates an enhanced view of the rear view of the control panel of FIG. 6.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### BRIEF SUMMARY

By developing aspects for a media processing device that allows assembly of said media processing device to be reduced, those developments are important for a user as a way to save time and production costs. By making components easier to reach or access, users can save time in assembling and building more media processing devices in less time.

Media processing devices, otherwise referred to herein as printers, are used in a variety of applications and environments. In certain embodiments the media processing device is a thermal printer, a mobile thermal printer, a radio frequency identification (RFID) encoder or other label producing means. In one embodiment, a media processing device comprises: a housing having a front portion, rear portion, and side portions, the front portion of the housing defining a plane; a control panel disposed on the front portion of the housing; the control panel comprising a fastener disposed a rear side of the control panel, the fastener connecting the control panel to the housing and having a long axis parallel to the plane of the front portion of the housing.

In some embodiments, a media processing device comprises: a housing having a front portion, rear portion, and side portions, the front portion of the housing defining a plane; a control panel disposed on the front portion of the housing; the control panel comprising a fastener disposed a rear side of the control panel, the fastener connecting the control panel to the housing and having a long axis parallel to the plane of the front portion of the housing.

In some embodiments, a media processing device comprises: a housing comprising a front portion, a first side portion, wherein the first side portion comprises a side plane and the front portion comprises a front plane and the side plane is perpendicular to the front planes; a control panel comprising: a front face; a rear face opposite the front face; a latch disposed on the rear face; and a bracket disposed on the rear face; wherein the bracket is configured to receive a fastener within a channel of the bracket along a long axis; a tab disposed on the front portion, the tab oriented perpendicularly to the front portion, wherein: when the control panel is mounted on the front portion of the housing, the latch passes through an aperture of the front panel and latches the control panel to the front portion of the housing via the aperture, the bracket passes through the front portion and aligns with the tab such that a hole in the tab is concentrically aligned with the channel such that a fastener disposed along the long axis can be inserted through the hole and secured within the channel.

In some embodiments, a method of mounting a control panel, the method comprising: aligning the control panel having a bracket and a latch with openings of a front portion of a housing, wherein the front portion of the housing comprises a front plane; disposing the bracket and the latch through the openings of the front portion of the housing such that the latch latches onto the front portion of the housing and the bracket passes through the opening of the front portion of the housing; when the bracket passes through the opening, aligning a channel disposed within the bracket with a hole in a tab of the front portion of the housing, wherein the channel comprises a long axis concentric to the channel, the long axis parallel to the front plane of the front portion of the housing; and inserting a fastener along the long axis through the hole in the tab and into the channel.

### DETAILED DESCRIPTION

The following detailed description of example implementations refers to the accompanying drawings. The same reference numbers in different drawings may identify the same or similar elements.

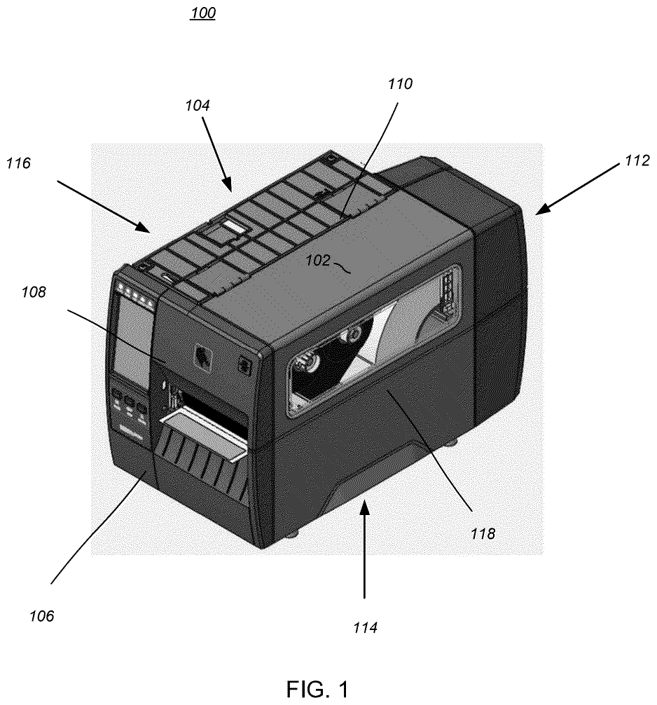

FIG. 1 depicts an example media processing device 100, a printer. The printer 100 as shown in FIG. 1 is a thermal transfer printer, however in other embodiments the printer may be a direct thermal printer, a tabletop printer, a mobile printer, an inkjet printer, a dye-sublimation printer, a RFID encoder, or any other type of device that can process media. The printer 100 comprises a housing 104. The housing 104 provides the overall casing around the printer 100 to provide structure and protection for internal components for the printer 100. The housing 104 includes a front portion 108, a top portion 110, a rear portion 112, a bottom housing 114, a first side portion 116, and a second side portion 118. In the illustrated embodiment, the top portion 110 and the bottom housing 114 are substantially parallel. In the illustrated embodiment, the front portion 108 and the rear portion 112 are substantially parallel and the first side housing 116 is substantially parallel to the second side portion 118. In the illustrated embodiment, a side is parallel to the side opposite, and perpendicular to the other four sides. For example, the front portion 108 is planar and parallel to the rear portion 112 that is planar. The front portion 108 is also perpendicular to the top portion 110, the bottom housing 114, the first side portion 116, and the second side portion 118, all of which are substantially planar as well.

The printer 100 further includes a lid 102 rotatably connected to the top portion 110. The lid 102 can rotate to an open position that allows a user to access inner components of the printer, and/or media processed by the printer.

The printer 100 further includes a control panel 106 mounted on the front portion 108. The control panel 106 comprises a user interface and control keys that are configured to operate the printer 100. The user interface is a touch screen, however in other embodiments the user interface can be an LCD display or other configurations as known in the art. The control panel 106 includes an electrical connector that allows communication between the control panel 106 and the printer 100. The nature of the control panel being mounted to the front portion 108 will be discussed in greater detail below.

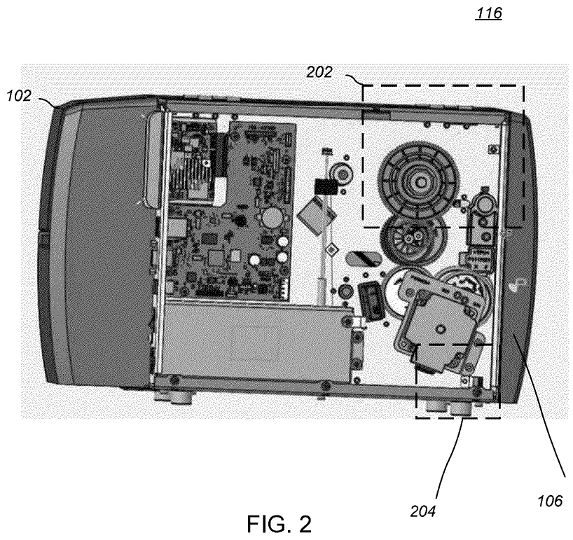

As illustrated in FIG. 2, a section of housing 102 has been removed from the first side 116 to display components within the printer 100. Section 202 is highlighted within FIG. 2 and will be further discussed below.

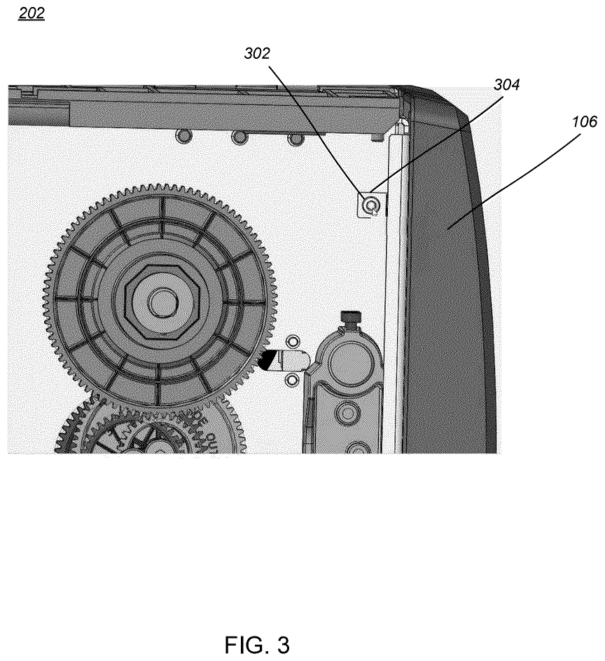

FIG. 3 illustrates an enhanced view of FIG. 2, focusing on section 202. As FIG. 3 depicts the first side portion 116, the side of the control panel 106 is depicted. The first side portion aligns with a side plane. FIG. 3 further illustrates a fastener 302 disposed within a tab 304. The tab 304 will be discussed further below, but the tab 304 is flat and comprises a tab plane being parallel to the side plane. The tab 304 includes a hole within the tab 304 for which the fastener 302 can pass. The fastener 302 is inserted into the hole in the tab 304 and the fastener has a long axis extending the length of the fastener 302, where the long axis and the first side portion 116 are substantially perpendicular. In another embodiment, the long axis and the first side portion 116 can be substantially perpendicular within a range (e.g., 80-100 degrees).

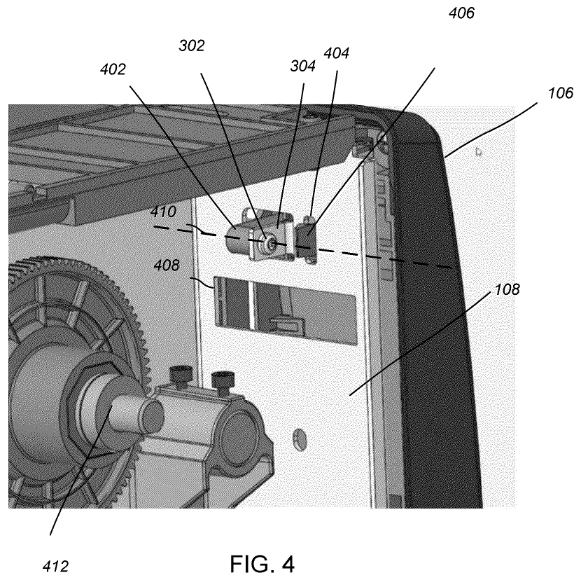

FIG. 4 depicts a different perspective of the section 202 as shown in FIGS. 2 and 3. As illustrated in FIG. 4, the fastener 302 passes through the tab 304 into a bracket 402. The bracket 402 is disposed on the rear of the control panel 106. As the control panel is aligned on the front housing for installation, the bracket 402 aligns with the tab 304 which allows the fastener 302 to pass through the tab 304 and secure into the bracket 402. The fastener 302 aligns the tab 304 with the fastener 302 along the long axis 410.

The long axis 410 is parallel to the front plane of the front portion 108 of the printer 100. The long axis 410 is also perpendicular to the side plane, however in other embodiments the long axis 410 is substantially perpendicular within range of 5-10 degrees to perpendicular. As shown in FIG. 4, the long axis 410 is representative of the alignment of the fastener 302, which aligns with how the fastener 302 needs to be installed. In other words, when a user is assembling the printer 100, the fastener 302 secures the bracket 402 of the control panel 106 to the tab 304 of the housing 102, the fastener 302 inserted through the hole in the tab 304 and a channel in the bracket 402 along the long axis 410, the channel will be discussed further below. The alignment of the long axis 410 is representative of how the fastener 302 needs to be installed.

As depictured in FIG. 4, printer components 412 are mounted within the housing 102. The printer components 412 as shown in FIG. 4 are intended to be for demonstrative purposes and can be different components in different locations in other embodiments, where the term printer components is intended to represent bulky elements of the media processing device within the housing 102. The printer components 412 may be located close to the front portion 108 of the housing 104 where it would make accessing connector elements of the front panel difficult. For example, if the long axis 410 was perpendicular to the front portion 108 of the housing 102, then a user would have to insert and drive in the fastener 302 from an angle that may cause the user's hands or tools to contact the printer components 412 or cause the tools to not fit at all. By having the long axis 410 be parallel to the front portion 108 of the housing 102, the fastener 302 can be inserted and driven from the first side portion 116 of the housing 102, which allows much more room for installation.

As can be seen in FIG. 4, an aperture 404 is located in the front portion 108, the aperture 404 is depicted as adjacent to the tab 304. In other embodiments, the aperture 404 may be located other places within the front portion 108. The aperture 404 is configured to receive a latch 406. The latch 406 as depicted is designed for insertion into the aperture 404. The latch 406 flexes away from a side of the aperture 404 until a lip on the latch 406 is fully past the aperture 404 and then the latch 406 flexes back and rests against the side wall of the aperture 404. The latch 406 is attached to the control panel 106 and operates to hold the control panel 106 against the front portion 108 during installation of the fastener 302. The latch 406 as depicted is configured to secure the control panel 106 against the front portion 108 such that the control panel 106 is held in position relative to the front portion 108.

FIG. 4 depicts an opening 408 in the front portion 108. In other embodiments, the opening 408 may be located in a different location on the front portion 108 or be a different shape than is shown in FIG. 4. The opening 408 is configured to receive electrical wires (not shown) from the control panel 106. In some embodiments, the electrical wires are a ribbon wire, a cable containing a plurality of smaller wires, or any other type of electrical wiring that is capable of transmitting either power, electrical signals, or both to and from the control panel 106 to a processor within the printer 100.

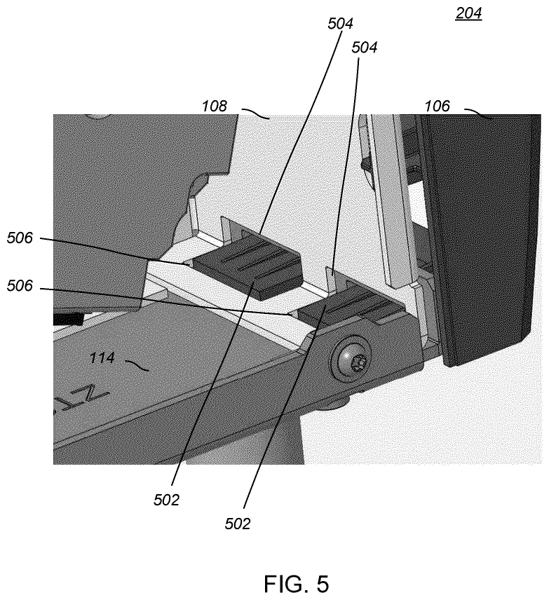

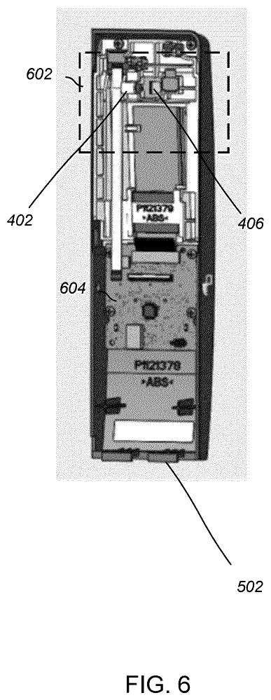

FIG. 5 depicts a view of section 204 from FIG. 2. FIG. 5 depicts an orthogonal view that displays the inside of the printer 100. As depicted in FIG. 5, feet 502 are extended from the bottom of the rear of the control panel 106. The feet 502 are flat projections with protrusions at a distal end from the control panel 106. The feet 502 pass through openings 504 where the projections fit into slots 506. The feet 502 are positioned on the control panel 106 such that when the feet 502 are positioned within the openings 504, the latch also lines up with the aperture 404. This can be further seen in FIG. 6.

FIG. 6 displays a back side of the control panel 106. The control panel 106 includes feet 502, the bracket 402 and the latch 406. The control panel 106 includes a processor on a circuit board 604. The circuit board 604 is designed to receive inputs from a user via elements on the front side of the control panel 106. The inputs received from the user are then transmitted to the printer 100. FIG. 6 further displays area 602 which is highlighted and will be discussed in further detail below.

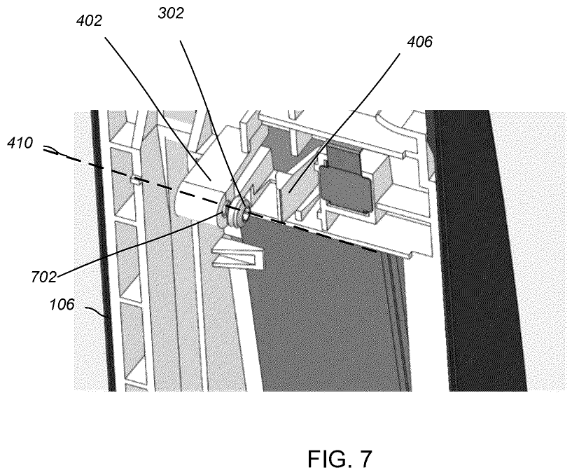

FIG. 7 illustrates area 602 in enhanced detail. FIG. 7 illustrates the bracket 402 and the latch 406 protruding from the rear of the control panel 106. The bracket 402 and the latch 406 are shown as being structurally integrated with the control panel 106. In some embodiments, the bracket 402 and the latch 406 are securely attached to the back of the control panel 106.

The bracket 402 further includes a channel 702 configured to receive the fastener 302. The channel 702 is straight-walled and is configured to receive a thread-forming screw like fastener 302, however in other embodiments, the channel 702 may be pre-threaded. The long axis 410 passes through a central axis of the channel 702.

FIG. 7 further illustrates how long axis 410 is oriented such that the fastener 302 is accessible from a side direction of the control panel 106 rather than a rear direction.

From the perspective of FIG. 7, the fastener 302 can be seen as inserted into the bracket 402. For installation of the control panel 106 from the embodiment shown in FIG. 7, the fastener 302 is first removed and then the control panel 106 is mounted to the front portion 108 of the housing 102.

To mount the control panel 106 to the front portion 108 of the housing 104, the control panel 106 must be aligned with the front portion 108 before the control panel 106 can be secured to the front portion 108. When aligning the control panel 106, the feet 502 are aligned with the openings 504, as shown in FIG. 5. By inserting the feet 502 into the openings 504, that allows the bottom of the control panel 106 to be aligned which allows the rest of the control panel 106 to also align. In other words, the feet 502 are configured to be set into place and have the control panel 106 to slide into place.

As the feet 502 are slid into place within the first portion 108 of the housing 104, the bracket 402 passes through the front portion 108 as the control panel 106 is placed against the front portion 108. Also, as the control panel 106 is fully pressed into place, the latch 406 passes through the aperture 404 and the latch 406 snaps into place.

In other words, at this time of installation, the feet 502 are supporting the control panel 106 against the front portion 108 and the latch 406 maintains the position of the control panel 106 up against the front portion 108. It is important to note that when installing the control panel 106, the latch 406 is designed to temporarily hold the control panel 106 in place. As the latch 406 holds the control panel 106 in place, the bracket 402 is aligned with the tab 304, which allows the user to drive a fastener 302 through the tab 304 and into the channel within the bracket 402.

The channel 702 includes the long axis extending through the channel 702 concentric to the channel. The long axis is substantially parallel to the front plane of the front portion of the housing and allows a user to insert a fastener along the long axis through the hole in the tab and into the channel. In some embodiments, the channel 702 is oriented such that the long axis is substantially perpendicular to the side plane. When the channel 702 is perpendicular to the side plane, a user can access the channel to install a fastener without having to worry about interference from a printer component.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A media processing device comprising:
a housing having a front portion, rear portion, and a side portion, the front portion of the housing defining a plane;
a control panel disposed on the front portion of the housing;
the control panel comprising a fastener disposed on a rear side of the control panel, the fastener connecting the control panel to the housing and having a long axis parallel to the plane of the front portion of the housing.

2. The media processing device of claim 1, further comprising a processor, wherein the front control panel is connected to the processor.

3. The media processing device of claim 1, wherein the second connection element comprises a tab configured to be received by a slot of the housing.

4. The media processing device of claim 1, wherein the housing comprises an aperture configured to receive the first connection element prior to the first connection element being fastened to the housing.

5. The media processing device of claim 1, wherein the long axis is perpendicular to the side portion of the housing.

6. The media processing device of claim 1, wherein the long axis is parallel to the front portion of the housing within a range of 5-10 degrees.

7. The media processing device of claim 1, further comprising a bracket protruding from the rear side of the control panel, the bracket having a channel disposed within the bracket wherein the channel is aligned with the long axis.

8. The media processing device of claim 7, wherein the bracket is adjacent to a tab of the housing, wherein the fastener passes through a hole of the tab before being received by the channel.

9. A media processing device comprising:
a housing comprising a front portion, a first side portion, wherein the first side portion comprises a side plane and the front portion comprises a front plane and the side plane is perpendicular to the front planes;
a control panel comprising:
a front face;
a rear face opposite the front face;
a latch disposed on the rear face; and
a bracket disposed on the rear face; wherein the bracket is configured to receive a fastener within a channel of the bracket along a long axis;
a tab disposed on the front portion, the tab oriented perpendicularly to the front portion, wherein:
when the control panel is mounted on the front portion of the housing, the latch passes through an aperture of the front panel and latches the control panel to the front portion of the housing via the aperture, the bracket passes through the front portion and aligns with the tab such that a hole in the tab is concentrically aligned with the channel such that a fastener disposed along the long axis can be inserted through the hole and secured within the channel.

10. The media processing device of claim 9, wherein the latch is adjacent to the bracket on the rear face of the control panel.

11. The media processing device of claim 9, wherein the control panel further comprises at least one foot disposed on the rear face of the control panel.

12. The media processing device of claim 11, wherein when the control panel is mounted on the front portion of the housing, the at least one foot is aligned with at least one opening in the front portion of the housing.

13. The media processing device of claim 9, wherein the control panel further comprises an electrical connection connected to a processor mounted within the housing.

14. The media processing device of claim 13, wherein the electrical connection passes through an opening in the front portion of the housing.

15. The media processing device of claim 9, wherein the fastener is installed into the channel from a direction of the first side portion.

16. A method of mounting a control panel, the method comprising:
aligning the control panel having a bracket and a latch with openings of a front portion of a housing, wherein the front portion of the housing comprises a front plane;
disposing the bracket and the latch through the openings of the front portion of the housing such that the latch latches onto the front portion of the housing and the bracket passes through the opening of the front portion of the housing;
when the bracket passes through the opening, aligning a channel disposed within the bracket with a hole in a tab of the front portion of the housing, wherein the channel comprises a long axis concentric to the channel, the long axis parallel to the front plane of the front portion of the housing; and
inserting a fastener along the long axis through the hole in the tab and into the channel.

17. The method of claim 16, further comprising inserting at least one foot disposed on the control panel through openings in the front portion of the housing.

18. The method of claim 16, wherein:
the housing further comprises a side portion of the housing;
the side portion having a side plane, the side plane perpendicular to the front plane; and
the long axis is perpendicular to the side plane.
